(19) United States
(12) Patent Application Publication
(10) Pub. No.: US 2012/0085135 A1
(43) Pub. Date: Apr. 12, 2012

(54) EXPANDABLE HANDCUFFS

(76) Inventor: Billie Louden, Denver, CO (US)

(21) Appl. No.: 13/172,688

(22) Filed: Jun. 29, 2011

Related U.S. Application Data
(60) Provisional application No. 61/390,683, filed on Oct. 7, 2010.

(51) Int. Cl. E05B 75/00

(52) U.S. Cl. 70/16

(57) ABSTRACT

The subject handcuffs can expand from a retracted position to an expanded position to allow individuals to be safety and effectively apprehended and restrained, including large waisted individuals. The handcuffs (100) include a first cuff (102) and a second cuff (104) interconnected by an expandable connecting assembly (106). The expansion mechanism (112) includes a spool (120) and a release (122). The spool (120) rotates to pay out or retract a cable (108). In operation, the handcuffs (100) can be secured to one wrist of the individual. The release (122) can then be operated to expand the handcuffs (100) so that the handcuffs (100) can be secured to the other wrist of the individual.

### CROSS-REFERENCE TO RELATED APPLICATION

This application claims priority and the benefit of the filing date under 35 U.S.C. 119 to U.S. Provisional Application No. 61/390,683, entitled, “EXPANDABLE HANDCUFFS,” filed on Oct. 7, 2010, the contents of which are incorporated herein as if set forth in full.

### BACKGROUND

Handcuffs have been used in one form or another for centuries. However, early handcuffs were a “one size fits all” device that often allowed a person with a smaller body type an easy escape. For example, a hand could slip out of the locked bracelet or cuff. Additionally, for persons with larger body types, handcuffs often inflicted great pain or damage to the body because the restraints were too tight when secured to the larger person.

Handcuff designs progressed to include an adjustable ratchet wrist restraint. The adjustable ratchet wrist restrain allowed any single handcuff to fit almost any sized wrist, thus preventing both escape and injury. Over the years incremental improvements were made to the designs, locks, and shape of the wrist bracelet as well as to the manufacturing processes used and the raw materials employed in making handcuffs. Today there are many manufacturers making similar handcuffs.

There are three distinct types of metal handcuffs in use in the world of law enforcement and that are approved for use in the United States by the National Institute of Justice. The most common type includes two adjustable metal cuffs that are held together by a short, flexible, three link chain (typically about 2 inches (5 cm) in length). This type of handcuff is depicted in FIG. 1. A lesser known variety links the two respective metal handcuffs together with a solid hinged connector. This second type of handcuff permits less movement, and can be hard to deploy. While less frequently used, there is a third type of handcuff which connects each wrist handcuff to the other with a rigid, unmovable bar. This can be a dangerous restraint, especially if the individual must be cuffed in front of their body as the bar itself can become a formidable weapon.

Handcuffs are generally used to restrain an individual when the open bracelet of one handcuff is placed around the wrist of the individual and locked in place. Then the restraint is completed by bringing the second wrist within the opening of the other handcuff and similarly locking it in place. The handcuff lock for each wrist bracelet is engaged when a swivel ratchet is pushed into the body of the handcuff and the teeth of the swivel ratchet engage a spring-loaded pawl located inside the locking mechanism.

In addition to these types of traditional handcuffs, flexible or plastic restraints, also known as “wrist ties,” “riot cuffs,” “zipcuffs” and other designations, often include flexible bands of plastic that can be tightened around a person's wrists and secured either in front or behind the person. Such plastic restraints are lightweight, disposable and inexpensive. They are therefore well-suited to occasions when a large number of people must be detained, such as during a riot or large-scale demonstration.

However, plastic restraints have a number of limitations. For example, restraints can generally only be used one time, cannot be adjusted once set in place and normally must be cut off the person's wrists to free the individual. Some versions provide a locking mechanism that can be used more than once, but are still limited to only a few uses before the plastic restraints become ineffective. Moreover, while potentially introducing some flexibility from standard metal handcuffs, in that plastic restraints might accommodate a person with larger wrists, plastic restraints still need to unite both hands at the middle of the detainee's back, and thus may be difficult to use on large individuals. Further, because plastic restraints typically cannot be released once they are put in place, they may need to be cut off the detainee when it is necessary to remove the restraints from a detainee (e.g., to be fingerprinted, to attend to personal bodily functions, etc.). Additionally, it may prove harder to apprehend an individual with flexible restraints, as it may be difficult to get an individual to willingly put their hands through the large loops so the plastic restraints can be tightened. Flexible restraints also are not as strong as metal handcuffs, and because plastic restraints typically cannot be loosened, there is a risk of nerve or soft-tissue damage to the wearer.

Law enforcement officers come into contact with a diverse group of people on a daily basis. Officers can be liable for civil or criminal charges for the improper use of handcuffs, especially when injury results. Behind-the-back handcuffing became standard in law enforcement during the 1960s, and it is considered to be the most secure approach by the majority of the police academies in the United States. It ensures that the detainee's hands are secured facing outward so the individual cannot reach across to the other hand or in any way work both hands together to effect an escape. Additionally, when a detainee is handcuffed behind their back the keyholes on each cuff are facing up and away from the detainee's hands, thus minimizing attempts to pick the lock or grasp an object that could be used as a weapon with one or both of the hands.

In this regard, when the individual to be detained is overweight, obese, or has a large girth, it can be difficult or impossible to bring the individual's wrists close enough together behind their back to be cuffed. Obesity is an ever growing problem that affects people around the world. Individuals with a large girth, upon being detained often cannot place their hands behind their backs comfortably. The need to detain such individuals has forced law enforcement to make often expensive and impractical changes to their traditional modes of operation, arrest, and detention.

For example, arresting officers are often forced to hook two sets of standard handcuffs together (often referred to as “daisy-chaining”) to detain such individuals. While the use of two sets of handcuffs may allow the person to be detained, it may also create an opportunity for escape if there is a great degree of slack between the two wrists. Such slack may be introduced by locking two standard handcuffs together in a daisy-chain configuration because such a configuration does not allow for adjustment of the amount of slack that results once the cuffs have been secured to the detainee. In such instances, if the individual is left unsupervised, even momentarily, he or she may be able to lower their hands to their feet, and step over the slack handcuff daisy-chain so that their wrists are now in front of the body. Then, given the opportunity, the detainee could use the chain of handcuffs to attack an officer from behind possibly harming or strangling the officer and allowing an escape and further crime to occur.

Additionally, even when an individual is physically capable of placing his or her hands behind their back to be handcuffed, if an individual is too dangerous, the officer may be forced to put the offender's arms behind them in a way that could injure the person. Any officer forced to do this may find themselves the subject of an internal affairs investigation and possibly a lawsuit. Such violent resistance to being arrested is an act that occurs often. The goal of any officer is to get the person under control as quickly as possible. Getting handcuffs on these offenders takes away most of the offender's ability to fight and to resist apprehension. A person, even if they are face down, can wildly swing their arms and grab or attack an officer. If one cuff is applied, the individual will often try and prevent the officer from grabbing the individual's free wrist. If the officer has to straddle the person in order to get the free arm closer, the officer is in a vulnerable position. This may be the case even for individuals who are not overweight or obese. For larger girthed individuals, the problems of resisting apprehension may be compounded as it may be even harder for an officer to engage the second cuff to a free hand of a detainee.

The use of multiple pairs of handcuffs to detain large individuals also introduces potential compromises for an officer and an increase in cost. Items on the duty belt of an officer are geared towards protection and restraint. There are a number of less-than-lethal devices officers have at their disposal such as pepper spray, tasers, batons, and as a lethal resort, a duty weapon. The need for carrying additional sets of handcuffs requires a double cuff case, which often forces officers to remove one or more of their weapons to accommodate the bulky case. Accordingly, the officer is left with fewer means of defense or restraint. There is also the issue of bulk and weight on the officer associated with carrying additional sets of handcuffs to be able to daisy-chain handcuffs together to accommodate larger individuals. One solution to these issues, in many precincts, has been to be team officers in sets of two in order to perform duties that would normally have been performed by a single officer. Needless to say this greatly increases the cost of law enforcement and provides less patrol coverage in small departments. Additionally, many officers are required to purchase their own handcuffs, thus subjecting the officers to the expense of a double purchase of handcuffs. Furthermore, prisons and agencies dealing with numerous offenders often purchase restraints in bulk. Therefore, purchasing extra handcuffs to accommodate special needs inmates may create a great financial burden to such organizations.

Law enforcement is an umbrella term that covers many areas. For example, in the United States, there are city police, county sheriffs, correction officers, federal officers, private investigators, and private security agents. Handcuffs may also be used by other private parties such as airline personnel or even medical personnel who may need to restrain an irrational human being. These organizations have one thing in common in that they all use handcuffs in the performance of their duties. Accordingly, the problems identified with traditional handcuffs discussed above may also be present in these contexts, particularly when securing an overweight or obese individual.

The trend toward being overweight or obese that is so evident in our society often puts an arresting officer in a difficult position and can mitigate against good law enforcement practices. Furthermore, tradition handcuffs are susceptible to the problems identified above in relation to the fixed, relatively short spread between the cuffs of the handcuffs.

### SUMMARY

As evident from the foregoing, the advances made in handcuff technology, such as flexible restraints and large-wrist metal cuffs, fail to fully address the problem of large waisted prisoners and how they may be safely and effective apprehended and restrained, preferably with their hands behind their backs. Consequently, attempts to provide for such individuals of large girth have been made that may significantly reduce the effectiveness of the handcuffs.

However, the present invention reduces the problems identified above by allowing the expansion of the cuffs of a handcuff between a retracted configuration and an expanded configuration. Accordingly, handcuffs according to the present invention help accommodate individuals of large girth while maintaining the efficacy of the cuffs. Furthermore, the cuffs of the present invention help in the apprehension of individuals who resist detention by allowing an officer a larger distance between the cuffs that can be reduced once the cuffs have been secured to the individual.

In this regard, a first aspect of the present invention includes a handcuff device having a first cuff for securably engaging a first wrist area of a subject to be restrained and a second cuff for securably engaging a second wrist area of the subject to be restrained. The handcuff device also includes an expandable connecting assembly connecting the first and second cuffs. The expandable connecting assembly has at least a retracted configuration where the first and second cuffs are separated by a first distance when fully separated under tension and a expanded configuration where the first and second cuffs are separated by a second distance greater than the first distance when fully separated under tension.

In one embodiment, the expanding connecting assembly is bi-directionally operable to permit expansion of the first cuff and second cuff from the retracted configuration to the expanded configuration and retraction of the first cuff and second cuff from the expanded configuration to the retracted configuration. The expandable connecting assembly is preferably biased to the retracted configuration. The expandable connecting assembly preferably also includes a release, where actuation of the release permits expansion of the connecting assembly. The connecting assembly may be retractable to the retracted configuration independent from the actuation of the release. In this regard, even when the release is not actuated, the expandable connecting assembly may permit the retraction of the cuffs to the retracted configuration. The connecting assembly preferably also includes a lock that is operable to secure the expandable connecting assembly to prevent expansion and retraction thereof.

In one embodiment, the connecting assembly comprises a cable connecting the first cuff and the second cuff. The connecting assembly is preferably adapted to withstand at least a 495 pound force static tensile load for at least 30 seconds. Additionally, the connecting assembly is preferably adapted to withstand at least a 300 pound force dynamic load.

In one embodiment, a first end of the cable is securely attached to the first cuff and a second end of the cable is operatively attached to a spool at the second cuff. The cable is wound about the spool when the spool rotates in a first direction corresponding to retraction of the first cuff and second cuff. Furthermore, the cable is unwound from the spool when the spool rotates in a second direction corresponding to expansion of the first cuff and second cuff. In this embodiment, the spool comprises a plurality of ratchet teeth adapted for interface with a pawl. The pawl is biased to mating engagement with the ratchet teeth to prevent rotation of the spool in the second direction. However, the pawl allows for rotation of the spool in the first direction. The handcuffs include a release that is operative to disengage the pawl from the ratchet teeth to allow for rotation of the spool in the second direction. The pawl is lockable with respect to the ratchet teeth to prevent rotation of the spool in the first and second direction. That is, the pawl may be locked such that the handcuffs cannot expand or retract and the spread of the cuffs is fixed. Preferably, the first distance is less than 3 inches (7.6 cm) and the second distance may be greater than 3 inches (7.6 cm). The first distance may be no more than about 2 inches (5 cm) and the second distance may be at least about 4 inches (10 cm).

A second aspect includes a method for use in handcuffing a subject. The method includes securing a first cuff to the subject, expanding a connecting assembly connecting the first cuff assembly to a second cuff assembly, and securing the second cuff to the subject. The connecting assembly can be expanded from a retracted configuration to an expanded configuration. The retracted configuration and expanded configuration may be similar to those described above with respect to the first aspect. The method may include retracting the connecting assembly after the first securing and second securing. In this regard, the connecting assembly can be moved to a partially retracted configuration between the expanded configuration and the retracted configuration.

In one implementation, the method includes actuating a release to allow for expansion of the connecting assembly. The method can further include locking the connecting assembly to prevent retraction and expansion thereof. The handcuffs can be expanded before they are secured to the subject or after one of the cuffs have been secured.

### BRIEF DESCRIPTION OF THE DRAWINGS

FIG. 1 is a front elevation view of handcuffs from the prior art.

FIG. 2 is a front elevation view of an embodiment of expandable handcuffs according to the present invention in a retracted configuration.

FIG. 3 is a front elevation view of the embodiment in FIG. 2 in an expanded configuration.

FIG. 4 is a plan view of a first cuff of the embodiment of FIG. 2.

FIG. 5 is a cutaway perspective view of an embodiment of an expansion mechanism of the embodiment according to FIG. 2.

FIG. 6 is a plan view of a second cuff of the embodiment of FIG. 2.

FIG. 7 is a plan view of the first cuff of the embodiment of FIG. 2, wherein a release is actuated.

FIG. 8 is a plan view of the first cuff of the embodiment of FIG. 2, wherein a lock is engaged.

FIG. 9 is a flow chart depicting an embodiment of a method for use in handcuffing a subject.

### DETAILED DESCRIPTION OF THE DRAWINGS

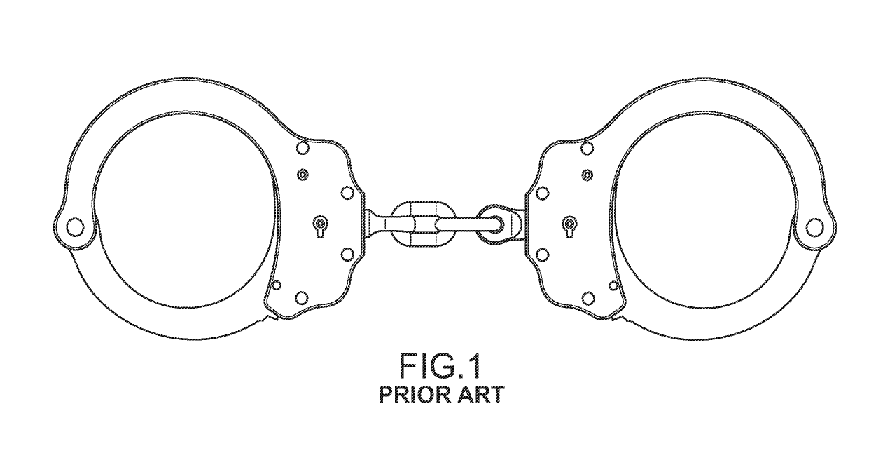

In conventional handcuffs, the cuff assemblies are generally interconnected by chain links such as those shown in FIG. 1. The chain links are relatively short such that the cuffs may be separated by the space of about 2 inches (5 cm) when the chain links are fully extended under tension (referred to herein as the “spread” of the cuffs). As noted above, such spacing may be insufficient, impractical, or hazardous for use with individuals of large girth. Additionally, in the case where such an individual struggles or resists detention, the conventional handcuffs shown in FIG. 1 may limit the ability of an officer to move the cuffs to the individual's wrist to close the cuff around the wrist of the struggling individual. Accordingly, the problems identified above may be present for handcuffs such as those shown in FIG. 1.

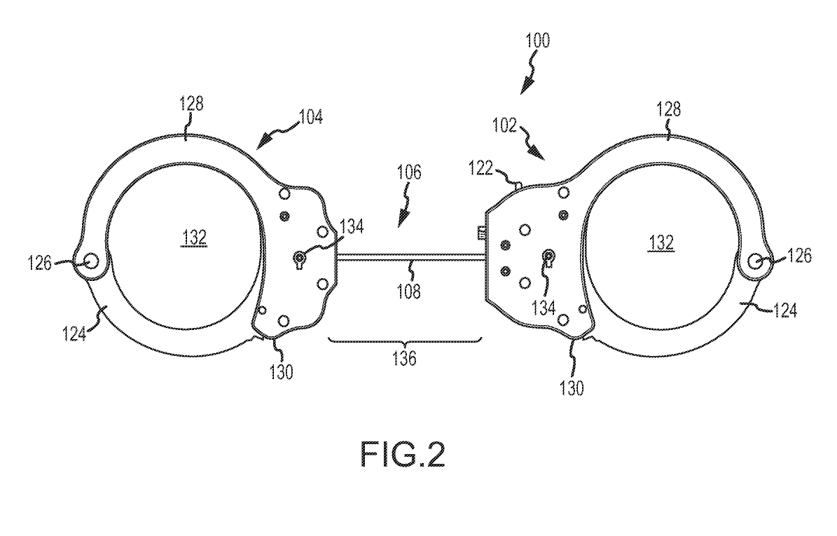

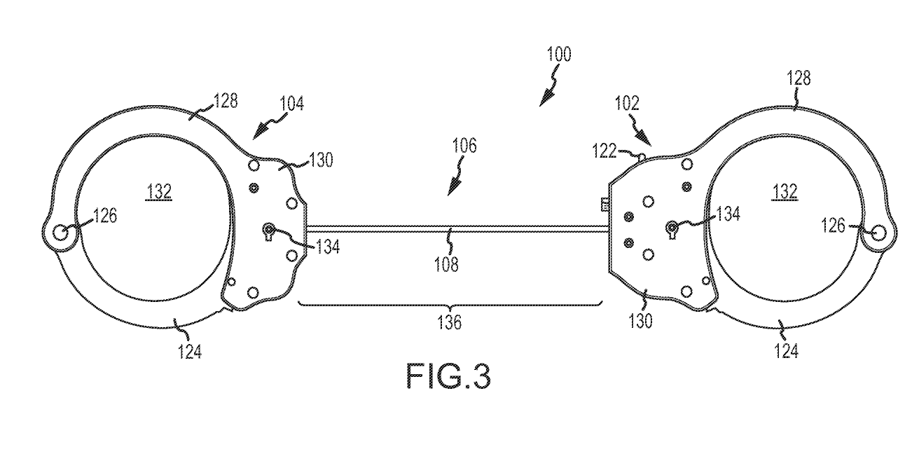

In contrast, an embodiment of a set of expandable handcuffs 100 is shown in FIG. 2. A first cuff 102 and a second cuff 104 of the expandable handcuffs 100 are interconnected by an expandable connecting assembly 106. The expandable connecting assembly 106 allows for the spread 136 between the first cuff 102 and the second cuff 104 to be expanded. Accordingly, the handcuffs 100 may overcome one or more of the problems identified above with respect to traditional handcuffs. The handcuffs 100 depicted in FIG. 2 include first and second ratchet-type cuffs 102, 104 for engaging the wrists of a subject to be restrained. The expandable attachment mechanism 106 includes a cable 108 extending between and connecting the first cuff 102 and the second cuff 104. The expandable attachment mechanism 106 facilitates at least two configurations of the handcuffs 100. As shown in FIG. 2, the handcuffs 100 are in a retracted configuration. As such, the spread 136 between the first cuff 102 and second cuff 104 may be about the same as the spread of traditional handcuffs described above. For example, the spread 136 in the retracted configuration may be less than about 3 inches (7.6 cm). In one embodiment, the spread 136 may be no more than about 2 inches (5 cm). The expandable attachment mechanism 106 may be expanded to an expanded configuration as shown in FIG. 3, wherein the expandable attachment mechanism 106 is expanded such that the spread 136′ of the first and second cuff assemblies is greater than about 3 inches (7.6 cm). In one embodiment, the spread 136′ in the expanded configuration is at least about 4 inches (10 cm).

The manner in which the cuffs 102 and 104 secure the wrists of an individual may be generally the same as conventional handcuffs. In the illustrated embodiment, the cuffs 102 and 104 are ratchet type handcuffs with a ratchet member 124 that is pivotal about a swivel 126. This allows the ratchet member 124 to pivot with respect to a body 130 of the cuff 102, 104 to allow for the individual's wrist to be positioned adjacent to an arcuate projection 128 extending from the cuff body 130. This allows the handcuffs 100 to be fitted to the subject's wrist. That is, each of the cuffs 102 and 104 is formed in two arcuate halves (e.g., one arcuate half formed by the ratchet member 124 and the other by the arcuate projection 128 rigidly extending from the body 130 of the cuff) that are interconnected at the swivel 126. The ratchet member 124 may be pivoted into engagement with the body 130 and locked such that the wrist of a subject may be securely disposed in an interior space 132 defined by the arcuate projection 128 and the ratchet member 124. In the closed position, the cuffs 102 and 104 cannot be opened without a key as will be described in greater detail below. In this regard, the ratchet member 124 of each cuff 102, 104 is toothed such that it can be advanced with respect to the body 130 but cannot be retracted therefrom without using the key inserted into a key hole 134 to release the ratchet member 124 as will be discussed in further detail below.

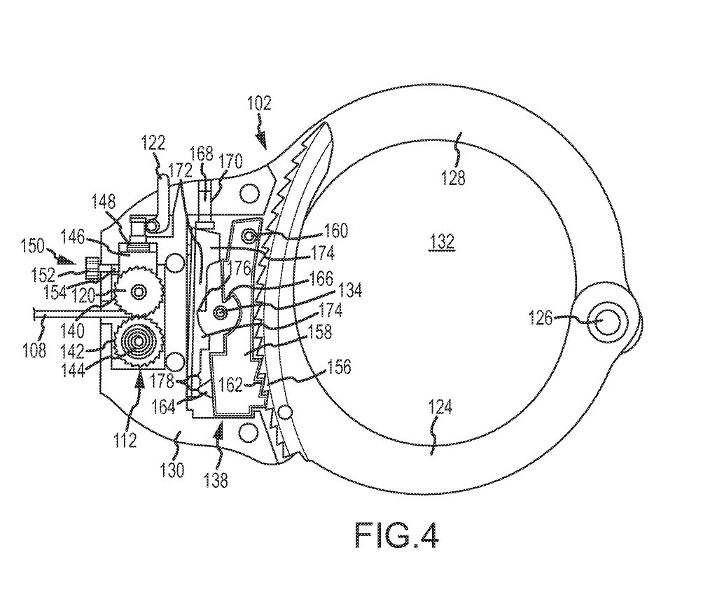

With additional reference to FIG. 4, a plan view of the first cuff 102 is shown such that the cuff locking mechanism 138 and expansion mechanism 112 are shown. The expansion mechanism 112 allows the cable 108 to be extended across a range of positions corresponding to different spreads between the expanded configuration and the retracted configuration of the handcuffs 100. Preferably, the expansion mechanism 112 allows the cuffs 102, 104 to be locked in substantially any position across the range of positions between the expanded configuration and the retracted configuration. In the illustrated embodiment, the handcuffs 100 are expandable between a range of spreads from about 2 inches (5 cm) or less to about 4 inches (10 cm) or more. This provides a relatively compact handcuff while accommodating a range of spreads sufficient to accommodate the girth of most individuals.

The expansion mechanism 112 may include a spool 120 and a release 122. As shown, the spool 120 may include ratchet teeth 140 disposed about the circumference of the spool 120. In this regard, a toothed biasing spool 142 may be in meshed engagement with the ratchet teeth 140. The toothed biasing spool 142 may be biased by a spring 144. Accordingly, the spring 144 and the toothed biasing spool 142 may interface with the spool 120 to urge the spool in a first direction (counter clockwise as shown in FIG. 4). The spool 120 includes a portion about which the cable 108 winds. For example, the spool 120 may rotate in the first direction resulting in the cable 108 being wound about the spool 120 thereby reducing the spread between the cuffs 102, 104 (i.e., corresponding to retraction of the cuffs 102 and 104). Because the spool 120 is biased in the first direction by the toothed biasing spool 142, the cable 108 is quickly retracted from the extended position when no tension is applied to the cable 108. In this manner, the handcuffs 100 automatically assume a compact configuration when not in use and will tend towards the retracted configuration.

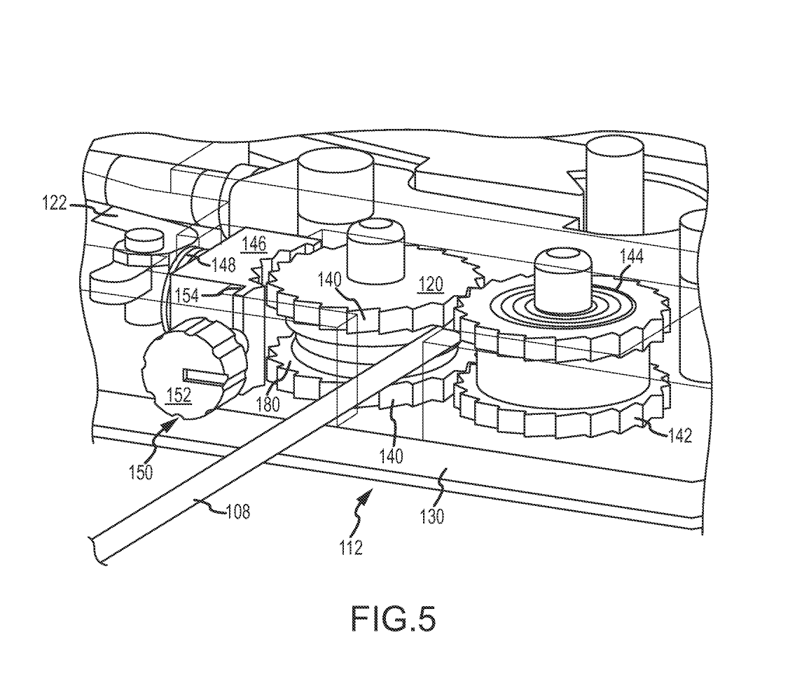

With further reference to FIG. 5, a cutaway perspective view of the expansion mechanism 112 is shown. As can be appreciated in this view, the spool 120 may have an annular slot 180 in which the cable 108 may be wound when in the retracted configuration. The diameter of the cable 108 may be less than the width of the annular slot 180 such that the cable 108 may lie adjacent to itself in the annular slot. This may help the spool 120 accommodate a greater length of the cable 108, thus facilitating a greater amount of retraction and expansion of the expandable connecting assembly 106.

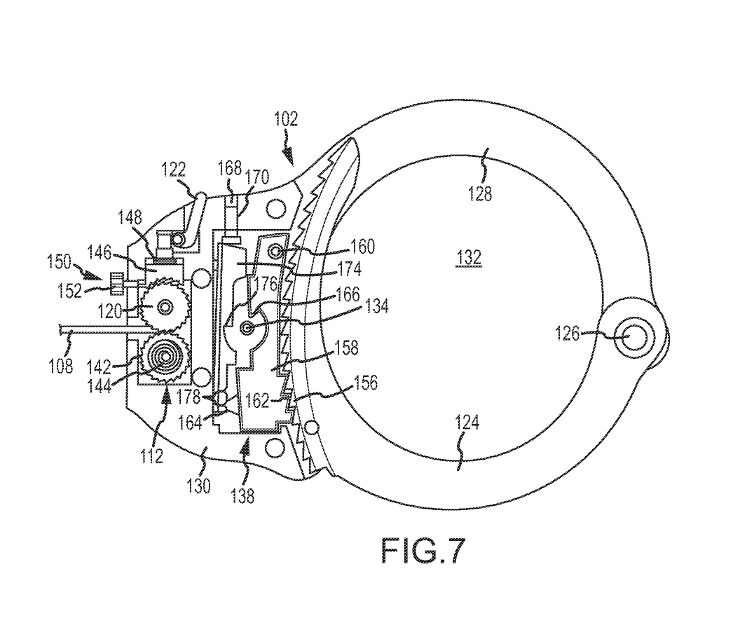

Additionally, the spool 120 may be freed to rotate in a second direction (e.g., clockwise as shown in FIG. 4). When the spool 120 rotates in the second direction, the cable 108 may be unwound from the spool 120 thereby increasing the spread between the handcuff assemblies 102, 104 (i.e., corresponding to expansion of the cuffs 102 and 104). Also, the assembly 112 can be locked in substantially any position across the range of spreads between the retracted configuration and the expanded configuration. To this end, the illustrated handcuffs 100 include a pawl 146 engageable with the spool 120. For example, the pawl 146 may have a shape corresponding to the ratchet teeth 140 of the spool 120. The pawl 146 is biased into mating engagement with the ratchet teeth 140 by way of a release spring 148. The pawl 146 can be released from the ratchet teeth 140 by actuation of the release 122. Activation of the release 122 results in the overcoming of the release spring 148 to move the pawl 146 away from the spool 120 such that the pawl 146 disengages the ratchet teeth 140 as shown in FIG. 7. This allows the spool 120 to rotate in the second direction to unwind the cable 108 from the spool 120 if sufficient tension is applied to the cable 108 to overcome the biasing force of the toothed biasing spool 142 to expand the spread of the handcuffs 100. The interaction of the pawl 146 and ratchet teeth 140 may allow the spool 120 to rotate in the first direction even when the pawl 146 is in biased engagement with the spool 120 (i.e., the release 122 is not actuated) such that the first and second cuffs 102, 104 may be retracted. In this regard, the shape of the pawl 146 and ratchet teeth 140 may allow for deflection of the pawl 146 away from the spool 120 when the spool 120 is rotated in the first direction (e.g., under the force of the toothed biasing spool 142). The biasing force acting on the spool 120 by way of the toothed biasing spool 142 may be such that the spool 120 rotates in the first direction to retract the cable 108 about the spool 120 unless a sufficient tension is applied to the cable 108.

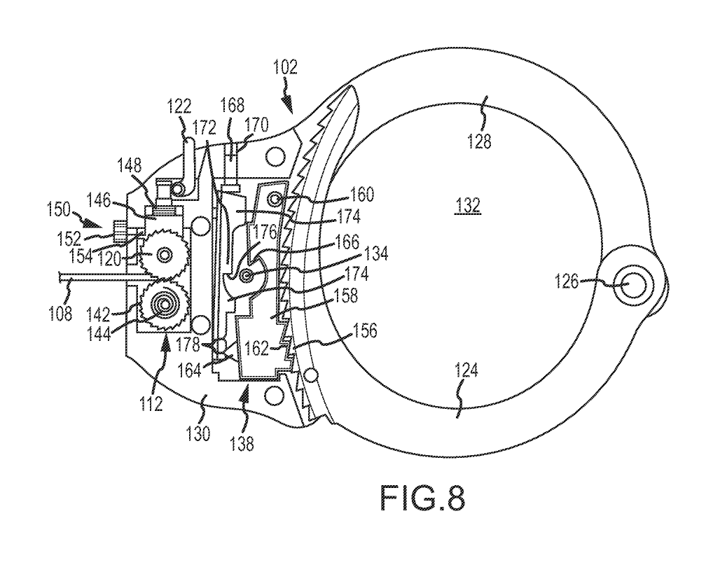

Additionally, as shown in FIG. 8, the release mechanism can be locked in a desired position by any suitable mechanism such as a button or, where it is desired to securely lock the release mechanism to prevent retraction and expansion of the first and second cuff 102 and 104, by way of a key or hand activated secondary locking mechanism. For example, a separate key may be provided for this purpose or the same key that operates the cuff locking mechanism 138 may operate the secondary locking mechanism. In the case where the same key operates the cuff locking mechanism 138 and the expansion mechanism 112, the expansion mechanism 112 may be released when the cuff 102 and/or 104 is unlocked or a separate process may be involved (e.g., the key may be turned a first direction to release the cuff locking mechanism 122 and a second direction to release the expansion mechanism 112).

In one embodiment, a screw lock 150 may be used to fix the spread of the first and second cuffs 102 and 104 (i.e., to prevent retraction and expansion of the cuffs 102, 104). The screw lock 150 may include a screw 152 threadably engaged with a body 130 of the cuff. The screw 152 may be threadably advanceable and retractable with respect to the pawl 146. In this regard, the pawl 146 may include a recess 154. The recess 154 may be positioned and shaped such that when the pawl 146 is in mating engagement with the ratchet teeth 140 of the spool 120, the screw 152 may be advanced into the recess 154 as shown in FIG. 8. In this regard, the pawl 146 may be prevented from being retracted from the spool 120 such that the pawl 146 prevents the spool 120 from rotating in the first and/or second direction effectively locking the first cuff and the second cuff 102 and 104 to prevent expansion and retraction thereof.

In one embodiment, the expandable connecting assembly 106, including the cable 108, may be capable of withstanding a 495 pound force static tensile load applied thereto for 30 seconds. Furthermore, the expandable connecting assembly, including the cable 108, may be capable of withstanding at least a 300 pound force dynamic load. Additionally, the cable 108 may be coated (e.g., with a rubberized material, a polymer, etc.). The coating on the cable 108 may help discourage individuals attempting to break the cable by abrading it with another material or using the cable 108 as a weapon or the like (e.g., using the cable 108 as a saw blade).

With continued reference to FIG. 4, and as briefly described above, the cuffs 102, 104 may be secured to a suspect by closing a ratchet member 124 to enclose the suspect's wrist in an enclosed area 132 of the cuff 102, 104. While the following description describes the first cuff 102, the second cuff 104 may be of substantially the same construction and will not be discussed separately. The ratchet member 124 may include a plurality of teeth 156. When the ratchet member 124 rotates with respect to the swivel 126 the ratchet member 124 may be disposed as shown in FIG. 4. A locking arm 158 may be disposed about a pivot 160 with corresponding toothed portion 162 that engages the ratchet teeth 156 of the ratchet member 124. The locking arm 158 may be in contact with a resilient member 164 which biases the locking arm 158 into a position such that the toothed portion 162 meshes with the ratchet teeth 156 of the ratchet member 124. When the ratchet member 124 is advanced into a closed position such as that shown in FIG. 4, the ratchet teeth 156 are advanced with respect to the toothed portion 162 such that the locking arm 158 is deflected to allow for passage of the ratchet portion 124 with respect to the locking arm 158 to close the cuff 102. Additionally, the shape of the ratchet teeth 156 and toothed portion 162 may prevent opening of the ratchet member 124 once engaged.

Upon insertion of a key into the key hole 134 and rotation in a counterclockwise direction as shown in FIG. 4, a key may engage a notch 166 defined on the locking arm 158 to deflect the locking arm 158 so that the toothed portion 162 is disengaged from the ratchet teeth 156 to allow for the opening of the ratchet member 124.

The cuff locking mechanism 138 may also include a secondary lock that when engaged prevents movement of the ratchet member 124 in either an opening or a closing direction. In this regard, the ratchet member 124 may be immobilized once fitted to a suspect such that the ratchet member 124 is not further advanced so as to help reduce the likelihood of pinching or otherwise further closing upon the suspect's wrist to cause damage thereto. The secondary lock may include a plug 168 disposed in a bore 170 extending through the body 130 of the cuff 102. The plug 168 may be depressed into the bore 170 such that the plug 168 may contact and may displace a slide 172. The slide 172 may have steps 174 shaped therein which when advanced by the plug 168 create an interference preventing the locking arm 158 from pivoting about the pivot 160. The interference created between the steps 174 of the slide 172 and the locking arm 158 may prevent substantially all deflection of the locking arm 158. In this regard, the toothed portion 162 of the locking arm 158 may be rigidly meshed with the ratchet teeth 156 of the ratchet member 124 to prevent any relative movement. This not only prevents the ratchet member 124 from being moved to an open position but also restricts the ratchet member 124 from further closing as the locking arm 158 cannot be deflected to allow for relative movement of the ratchet teeth 156 and toothed portion 162 normally facilitated by the resilient member 164. The slide 172 may also include a notch 176 that is engaged by a key upon clockwise rotation thereof to disengage the steps 174 of the slide 172 from the locking arm 158 such that the locking arm 158 may be deflected about the pivot 160. As depicted, the slide 172 includes indentations in which the resilient member 164 may reside. The movement of the resilient member 164 to a respective one of the indentations 178 may help prevent movement of the slide 172. The engagement of an indentation 178 and resilient member 164 may also provide tactile feedback regarding movement of the slide 172 into the locked and unlocked position.

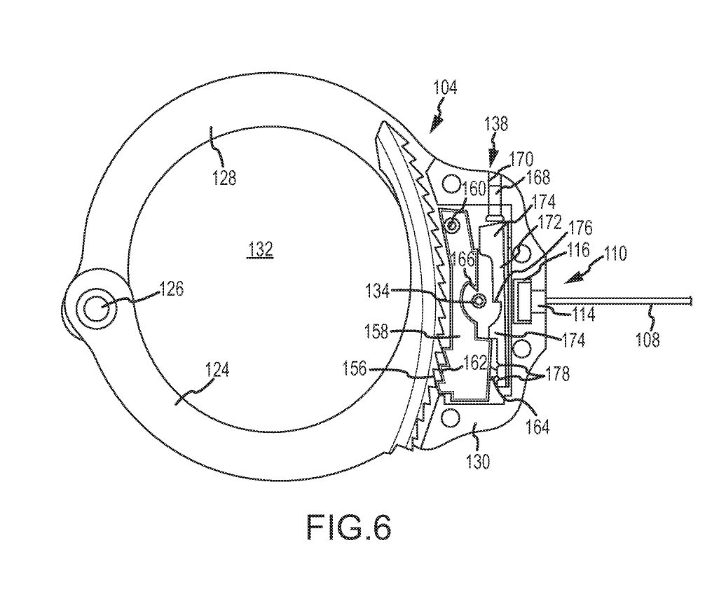

With additional reference to FIG. 6, a plan view of the second cuff 104 is shown. As stated above, the second cuff 104 may have a substantially similar cuff locking mechanism 138 as that described above with regard to the first cuff 102. Additionally, the second cuff 104 may include an anchor assembly 110 for attachment of a second end of the cable 108 to the second cuff 104. In the illustrated embodiment, the anchor assembly 110 comprises a chamber 116 defined in the body 130 of the cuff 104 corresponding to an expanded terminal end 114 of the cable 108. The chamber 116 captures the expanded terminal end 114. In this manner, an end of the cable 108 is captured by the chamber 116 and is rigidly connected to the cuff 104, while still providing for a degree of swivel and rotation as the attached handcuff is moved from one position to another. If desired, the chamber 116 may be pivotally mounted on the cuff 104 to provide a moveable joint while maintaining a substantially permanent connection.

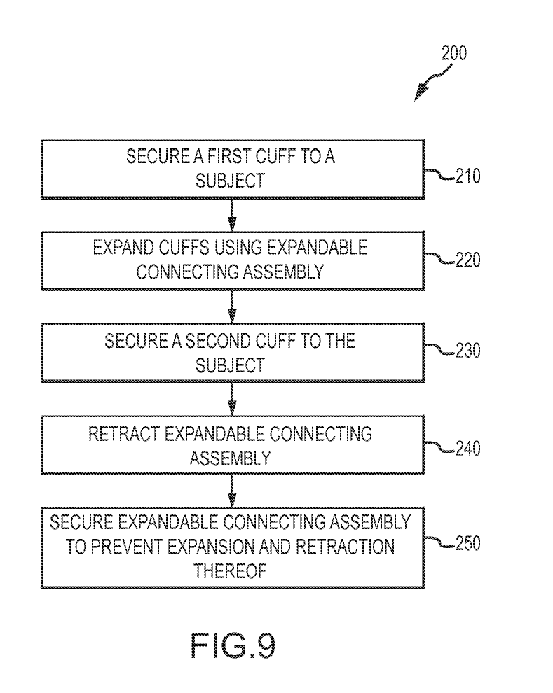

Additionally, a method 200 for use in handcuffing a subject may also be provided as depicted in the flow chart of FIG. 9. The method 200 includes securing 210 a first cuff to a subject. The method further includes expanding 220 the cuffs using an expandable connecting assembly. The expanding 220 may include expanding the cuffs from a retracted configuration to an expanded configuration. Furthermore, the expanding 220 may include actuating a release to allow for the expansion of the cuffs.

The method 200 further includes retracting 240 the expandable connecting assembly. The retracting 240 may include retracting the expandable connecting assembly to a retracted configuration. In this regard, the expandable cuffs may be used on an individual accommodated by traditional cuffs. However, the expanding 220 may provide an officer securing the subject additional spread between the cuffs to assist in securing 230 the second cuff to the suspect.

Alternatively, the retracting 240 may include retracting the expandable connecting assembly to a partially retracted configuration between the expanded configuration and the retracted configuration. In this regard, when securing an individual of large girth with the cuffs, the cuffs may be retracted 240 relative to the expanded configuration, yet still be expanded from the retracted configuration. In fact, any degree of retraction may be provided to accommodate individuals of different sizes.

In any regard, the method 200 may also include securing 250 the expandable connecting assembly to prevent retraction and expansion thereof. As such, when positioned between the expanded and retracted configurations, the expanding connecting assembly may be locked to prevent expansion of the cuffs. This may ensure that a suspect cannot further expand the cuffs. This may also ensure that the cuffs are not further retracted so as to reduce the likelihood that the cuffs cause harm to a suspect.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A handcuff device, comprising:
a first cuff for securably engaging a first wrist area of a subject to be restrained;
a second cuff for securably engaging a second wrist area of the subject to be restrained; and
an expandable connecting assembly connecting the first and second cuffs, the expandable connecting assembly having at least a retracted configuration where the first and second cuffs are separated by a first distance when fully separated under tension and a expanded configuration where the first and second cuffs are separated by a second distance greater than the first distance when fully separated under tension.

2. A handcuff device according to claim 1, wherein the expanding connecting assembly is operable to permit expansion of the first cuff and second cuff from the retracted configuration to the expanded configuration and retraction of the first cuff and second cuff from the expanded configuration to the retracted configuration.

3. A handcuff device according to claim 2, wherein the expandable connecting assembly is biased to the retracted configuration.

4. A handcuff device according to claim 3, wherein the expandable connecting assembly includes a release, wherein actuation of the release permits expansion of the expandable connecting assembly.

5. A handcuff device according to claim 4, wherein the expandable connecting assembly is retractable to the retracted configuration independent from the actuation of the release.

6. A handcuff device according to claim 5, wherein the expandable connecting assembly includes a lock, wherein the lock is operable to secure the expandable connecting assembly to prevent expansion and retraction thereof.

7. A handcuff device according to claim 2, wherein the expandable connecting assembly comprises a cable.

8. A handcuff device according to claim 7, wherein the expandable connecting assembly is adapted to withstand at least a 495 pound force static tensile load for at least 30 seconds.

9. A handcuff device according to claim 8, wherein the expandable connecting assembly is adapted to withstand at least a 300 pound force dynamic load.

10. A handcuff device according to claim 7, wherein a first end of the cable is securely attached to the second cuff and a second end of the cable is operatively attached to a spool at the first cuff.

11. A handcuff device according to claim 10, wherein the cable is wound about the spool when the spool rotates in a first direction corresponding to retraction of the first cuff and second cuff and the cable is unwound from the spool when the spool rotates in a second direction corresponding to expansion of the first cuff and second cuff.

12. A handcuff device according to claim 11, wherein the spool comprises a plurality of ratchet teeth adapted for interface with a pawl.

13. A handcuff device according to claim 12, wherein the pawl is biased to mating engagement with the ratchet teeth to prevent rotation of the spool in the second direction.

14. A handcuff device according to claim 13, wherein the pawl allows for rotation of the spool in the first direction.

15. A handcuff device according to claim 14, wherein a release is operative to disengage the pawl from the ratchet teeth to allow for rotation of the spool in the second direction.

16. A handcuff device according to claim 15, wherein the pawl is lockable with respect to the ratchet teeth to prevent rotation of the spool in the first and second direction.

17. A handcuff device according to claim 1, wherein said first distance is less than three inches and said second distance is greater than three inches.

18. A handcuff device according to claim 1, wherein said first distance is no more than about 2 inches and said second distance is at least about 4 inches.

19. A method for use in handcuffing a subject, comprising the steps of:
first securing a first cuff to the subject;
expanding an expandable connecting assembly connecting the first cuff assembly to a second cuff assembly; and
second securing the second cuff to the subject.

20. A method according to claim 19, wherein the expanding comprises expansion of an expandable connecting assembly from a retracted configuration to an expanded configuration.

21. A method according to claim 20, further comprising:
retracting the expandable connecting assembly after the first securing and second securing.

22. A method according to claim 21, wherein the retracting comprises retraction of the expandable connecting assembly from the expanded configuration to a partially retracted configuration between the expanded configuration and the retracted configuration.

23. A method according to claim 16, further comprising:
actuating a release to allow for expansion of the expandable connecting assembly.

24. A method according to claim 23, further comprising:
locking the expandable connecting assembly to prevent retraction and expansion thereof.

25. A method according to claim 19, wherein the expanding occurs after securing the first cuff to the subject.
